(19) United States
(12) Patent Application Publication
(10) Pub. No.: US 2025/0307694 A1
(43) Pub. Date: Oct. 2, 2025

(54) ENHANCING ANOMALY DETECTION SYSTEMS THROUGH INTELLIGENT MANAGEMENT OF FEEDBACK AND MODEL RETRAINING

(71) Applicant: Oracle International Corporation, Redwood Shores, CA (US)

(72) Inventors: Shrinidhi Mahishi, Karnataka (IN); Suresh Golconda, Santa Clara, CA (US); Vidya Mani, Karnataka (IN); Karthik GVD, Karnataka (IN)

(73) Assignee: Oracle International Corporation, Redwood Shores, CA (US)

(21) Appl. No.: 18/621,366

(22) Filed: Mar. 29, 2024

(51) Int. Cl. G06N 20/00

(52) U.S. Cl. CPC G06N 20/00

(57) ABSTRACT

A system manager is implemented on one or more computing devices operating according to special-purpose instructions to detect anomalies and iteratively collect feedback for model re-evaluation. The system manager trains a machine learning model to detect anomalies and determines an accuracy score of the trained model at detecting anomalies in a set of data items. The system manager also determines a contiguous anomaly score value region that includes a threshold portion of incorrectly labeled outputs. The trained model is used to make predictions on production data, and the system manager determines an accuracy of the predictions by selecting a subset of the production data within the contiguous anomaly score value region, clustering the subset into clusters, and selectively sampling data items from the clusters. The accuracy of the predictions on the production data is combined with the accuracy score of the trained model to determine an updated accuracy score. The system manager determines whether to retrain the model based on the updated accuracy score.

### BACKGROUND

Companies and individuals rely on software to support nearly all aspects of business and life. Much of this software automates the collection and management of data to support basic tasks, which may also be implemented in software. Software is becoming increasingly reliant on machine learning to extend functionality even when supporting information or answers to user questions are not known. Because such a variety of software depends on machine learning, machine learning and artificial intelligence, which often leverages machine learning, have become cornerstone computing technologies that are evolving independently to accommodate even more use cases.

Machine learning relies on known data values to determine value co-occurrences or other patterns among the known data values and, optionally, to predict unknown data values. Some of the known values may come from labels, which may be provided as examples of correct predictions of the unknown values. In other examples, the known values are historical data, and predictions may still be made if the prediction is based on an unknown value that occurs in a known pattern with other known values. More generally, the known data is used to train a machine learning model that may be used to predict the unknown data.

The detected patterns from one set of data or one portion of a set of data may be used to train a machine learning model to predict missing values in another set of data or another portion of the set of data. If the sets of data or portions of sets of data have similar distributions and are derived from the same or similar sources, the value co-occurrences and other patterns in one set of data should be similar to the co-occurrences and other patterns in the other set of data. The model may be validated if the model is accurate in determining missing values for the other set of data or other portion of the set of data.

A single trained machine learning model may be used and re-used to predict values for vast quantities of additional data that may even exceed the amount of data used to initially train the machine learning model. In a simple example, an initial set of data may contain the values “temperature=150 degrees” and “temperature=160 degrees” that co-occur with the value “too hot,” and the values “temperature=140 degrees” and “temperature=130 degrees” that co-occur with the value “okay.” Based on these value co-occurrences, the model may learn to classify temperatures below 140 degrees as “okay” and temperatures above 150 degrees as “too hot,” with some uncertainty about temperatures that did not occur in the initial set of data.

If the machine learning model is trained to make data-driven predictions at one point in time, then, at a later point in time, the data-driven assumptions made as part of the data-driven predictions may or may not still be valid. The model's predictions may remain accurate over time or become less and less accurate over time. In the latter scenario, the performance of software-driven decision-making may also degrade over time, resulting in lower software value. Referring to the simple example above, what once may have been considered too hot may no longer be considered too hot. Or, the model may be completely unaware that there is also a temperature that is considered “too cold.”

Retraining a model may be expensive and may include the process of re-detecting patterns in a set of data or a portion thereof and re-validating a model as effective to predict values for a different set of data or a different portion of the set of data. Retraining the model may consume computing resources for evaluating data relationships and running tests, storage resources for storing portions of the set of data, patterns detected, and a new model in addition to the existing model. Retraining a model too infrequently may result in poor model performance, and retraining the model too frequently may result in wasted resources yielding little or no model performance benefit.

### BRIEF SUMMARY

A system manager is implemented on one or more computing devices operating according to special-purpose instructions to detect anomalies and iteratively collect feedback for model re-evaluation. The system manager trains a machine learning model to detect anomalies and determines an accuracy score of the trained model at detecting anomalies in a set of data items. The system manager also determines a contiguous anomaly score value region that includes a threshold portion of incorrectly labeled outputs. The trained model is used to make predictions on production data, and the system manager determines an accuracy of the predictions by selecting a subset of the production data within the contiguous anomaly score value region, clustering the subset into clusters, and selectively sampling data items from the clusters. The accuracy of the predictions on the production data is combined with the accuracy score of the trained model to determine an updated accuracy score. The system manager determines whether to retrain the model based on the updated accuracy score.

In one embodiment, a computer-implemented method includes determining a first accuracy score of a trained machine learning model at determining anomalies in a first set of data items at least in part by providing a first unlabeled version of the first set of data items to the trained machine learning model as a first set of inputs to generate a first set of outputs of the trained machine learning model. The first set of outputs is labeled with a first set of anomaly scores. Determining the first accuracy score further includes comparing the first set of outputs of the trained machine learning model to a first labeled version of the first set of data items to determine a first set of incorrectly labeled outputs. The computer-implemented method also determines a contiguous anomaly score value region that includes a threshold portion of the first set of incorrectly labeled outputs, one or more outputs of the first set of outputs labeled as anomalous, and one or more outputs of the first set of outputs labeled as not anomalous. The computer-implemented method receives a second set of data items that have not been labeled. The second set of data items is provided to the trained machine learning model as a second set of inputs to generate a second set of outputs of the trained machine learning model. The second set of outputs is labeled with a second set of anomaly scores. The computer-implemented method determines an updated accuracy score of the trained machine learning model at determining anomalies in a superset of data items comprising the first set of data items and the second set of data items at least in part by selecting a second subset of data items within the contiguous anomaly score value region. The second subset of data items has fewer items than the second set of data items. Determining the updated accuracy score further includes clustering the second subset of data items into a plurality of clusters based at least in part on one or more feature values of the second subset of data items. Determining the updated accuracy score further includes selecting a third subset of data items from the second subset of data items such that the third subset has fewer items than the second subset, and the third subset has one or more data items in each cluster of the plurality of clusters. Labeled feedback is collected for the third set of data items. The computer-implemented method determines a second accuracy score at least in part by comparing, from the trained machine learning model, a third subset of labeled outputs of the third subset of data items to the labeled feedback. The first accuracy score is combined with the second accuracy score. Based at least in part on the updated accuracy score, the computer-implemented method determines whether the trained machine learning model satisfies one or more conditions for retraining the trained machine learning model. Based at least in part on determining that the trained machine learning model satisfies the one or more conditions, the computer-implemented method initiates retraining of the trained machine learning model.

In a further embodiment, the computer-implemented method includes sending a notification to an administrator of the trained machine learning model. The notification provides a summary comprising the updated accuracy score and a time for the retraining.

In a further embodiment, the computer-implemented method includes initiating the retraining at least in part by scheduling the retraining based at least in part on two or more different frequencies by which data items are provided to the trained machine learning model over two or more windows of time. The retraining is scheduled for a particular window of time of the two or more windows of time.

In a further embodiment, the trained machine learning model is trained to predict multivariate anomalies in a physical system. The second subset of data items comprise sensor values from sensors measuring physical properties of the physical system. The sensors are separately identified and tracked in an anomaly detection platform, and the sensors stream the second subset of data items into the anomaly detection platform using connections that provide sensor-identifying information.

In a further embodiment, selecting the third subset of data items is performed at least in part by randomly selecting a unique data item from the second subset of data items, and assigning the unique data item to a particular cluster of the plurality of clusters. The randomly selecting is re-performed if adding the unique data item to the third subset of data items would result in an over-representation of the particular cluster.

In a further embodiment, the computer-implemented method includes receiving a third set of data items that have not been labeled. The computer-implemented method provides the third set of data items to a second trained machine learning model as a third set of inputs to generate a third set of outputs of the second trained machine learning model. The third set of outputs is labeled with a third set of anomaly scores. The computer-implemented method determines a second updated accuracy score of the second trained machine learning model at determining anomalies in a second superset of data items comprising the first set of data items and the third set of data items at least in part by selecting a fourth subset of data items within a second contiguous anomaly score value region. The fourth subset of data items has fewer items than the third set of data items. Determining the second updated accuracy score further includes clustering the fourth subset of data items into a second plurality of clusters based at least in part on one or more feature values of the fourth subset of data items. Determining the second updated accuracy score further includes selecting a fifth subset of data items from the fourth subset of data items such that the fifth subset has fewer items than the fourth subset, and the fifth subset has one or more data items in each cluster of the second plurality of clusters. Second labeled feedback is collected for the fifth subset of data items, and a third accuracy score is determined at least in part by comparing, from the second trained machine learning model, a fifth subset of labeled outputs of the fifth subset of data items to the second labeled feedback. Determining the second updated accuracy score further includes combining the third accuracy score and a previous accuracy score. Based at least in part on the second updated accuracy score, the computer-implemented method determines whether the second trained machine learning model satisfies the one or more conditions. Based at least in part on determining that the second trained machine learning model does not satisfy the one or more conditions, the computer-implemented method adds the second labeled feedback to at least the first set of data items without initiating retraining of the second trained machine learning model.

In a further embodiment, the computer-implemented method includes retraining the trained machine learning model at least in part by tuning one or more hyperparameters of the trained machine learning model based at least in part on the third subset of labeled outputs.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart showing an example process for detecting anomalies and iteratively collecting feedback for model re-evaluation.

FIG. 2 illustrates a system for detecting anomalies and iteratively collecting feedback for model re-evaluation.

FIG. 3 illustrates a region of prediction uncertainty from which to sample items for feedback collection.

FIG. 4 depicts a simplified diagram of a distributed system for implementing certain aspects.

FIG. 5 illustrates an example computer system that may be used to implement certain aspects.

### DETAILED DESCRIPTION

Computer-implemented techniques are provided herein for detecting anomalies and iteratively collecting feedback for model re-evaluation. A system manager determines an accuracy score of a trained machine learning model and a contiguous anomaly score value region that includes a threshold portion of incorrectly labeled outputs by the trained model. The trained model is then used to make predictions on production data, and the system manager determines an updated accuracy score based on an accuracy of a selective sampling of the predictions that are within the contiguous anomaly score value region. The system manager determines whether to retrain the model based on the updated accuracy score. In various embodiments, the techniques for detecting anomalies and iteratively and efficiently collecting feedback for model re-evaluation are implemented using non-transitory computer-readable storage media to store instructions which, when executed by one or more processors of a computer system, cause display of anomaly notifications and a user interface for collecting feedback. The techniques for detecting anomalies and iteratively and efficiently collecting feedback for model re-evaluation may be implemented on a local and/or cloud-based computer system that includes processors and a display for showing notifications and/or collecting feedback. The computer system may communicate with client computer systems for detecting anomalies and iteratively and efficiently collecting feedback for model re-evaluation.

A description of how to detect anomalies and iteratively and efficiently collect feedback for model re-evaluation is provided in the following sections:
TRAINING MACHINE LEARNING MODELS TO MAKE PREDICTIONS
ESTIMATING ACCURACY OF MACHINE LEARNING MODELS
DETERMINING A REGION OF PREDICTION UNCERTAINTY
USING A MODEL TO MAKE PREDICTIONS
FILTERING ITEMS IN THE REGION OF PREDICTION UNCERTAINTY
SELECTIVELY SAMPLING THE FILTERED ITEMS
ITERATIVELY COLLECTING FEEDBACK
UPDATING THE ACCURACY SCORE
DETERMINING WHETHER TO TRIGGER AN ACTION
ENHANCING ANOMALY DETECTION SYSTEMS FOR THE INTERNET OF THINGS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Training Machine Learning Models to Make Predictions

In one embodiment, a model is trained to predict an output. The data available for training a model may include known examples of the output, which may be known from being labeled by a human, from being labeled by a machine, or otherwise from being part of or a dimension of the set of known data. The data available for training the model is separated into a set of training data and a set of test data, for example, using 70% as the training data and 30% as the test data, 80% as the training data and 20% as the test data, or any other split between training data and test data. A machine learning algorithm may use the set of training data to select parameters that are relevant to predict the output as well as defining weights of the parameters themselves, weights of embeddings of the parameters, weights of embeddings of combinations of the parameters, and/or weights of embeddings of relationships or patterns among the parameters.

Once the model is trained using the set of training data, the model may be tuned with a set of validation data selected from the set of test data, for example, using 20% or any other portion of the test set. The tuning process may involve iteratively evaluating performance of the model using the selected parameters and adjusting hyperparameters such as those that define a preferred depth or width of the model, a number of nodes or layers in a neural network, a number of branches in a decision tree, and other factors such as those that balance compute time and resources consumed with model accuracy. The model may then be tested using the remainder of the test set. The test set may include data value combinations that are not present in the training data, and the model may make correct predictions for some of those unknown combinations and incorrect predictions for others of those unknown combinations, depending on the data patterns detected. Testing the model is described in more detail in the next section.

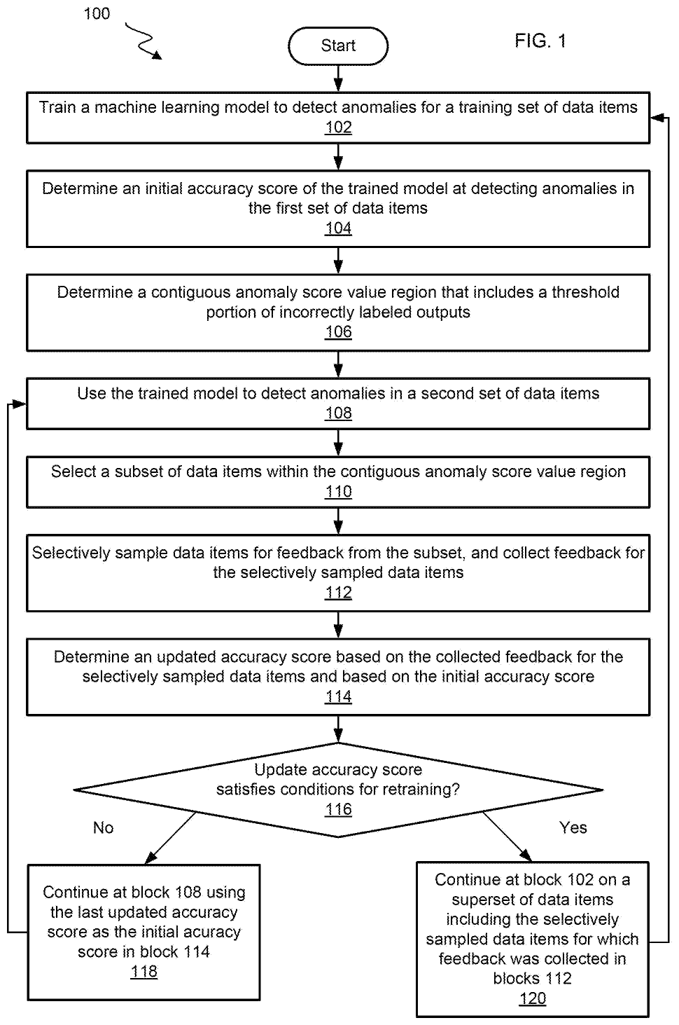

FIG. 1 illustrates a flow chart showing an example process 100 for detecting anomalies and iteratively collecting feedback for model re-evaluation. FIG. 1 starts at block 102, where a machine learning model is trained to detect anomalies for a training set of data items. For example, the first set of data may be a first subset of data (training data) available for training, and the model may be tuned on a second subset of data (validation data, which may be selected from test data) available for training and tested on a third subset of data (test data, which may exclude data used for validation) available for training. The machine learning model may then be used in block 108 to detect anomalies in a second set of data items.

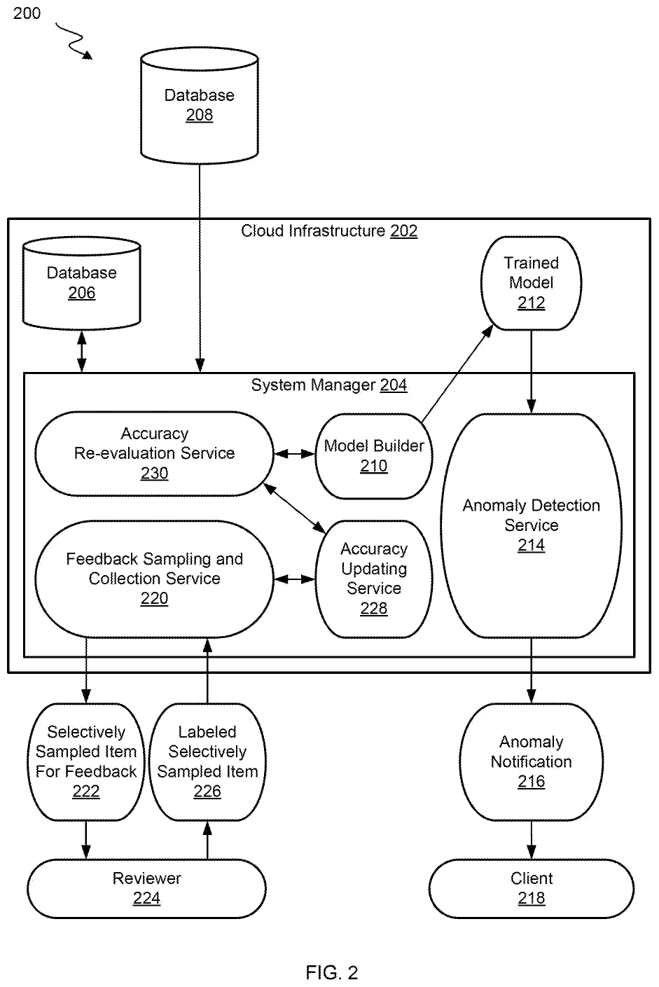

FIG. 2 illustrates a system for detecting anomalies and iteratively collecting feedback for model re-evaluation. In FIG. 2, a model builder 210 of a system manager 204 in cloud infrastructure 202 of system 200 may use one or more machine learning algorithms, or a blend of machine learning algorithms, to construct a trained model 212. The system manager is implemented on one or more computing devices operating according to special-purpose instructions to detect anomalies and iteratively collect feedback for model re-evaluation. Model builder 210 may access historical data from database 206 within cloud infrastructure 202 and/or database 208 outside cloud infrastructure 202. Model builder 210 may use labels in the historical data to generate a supervised machine learning model that is based on the labels, or may use patterns of historical data value co-occurrences to generate an initially unsupervised machine learning model that is based on the patterns of value co-occurrences that have been observed historically. The unsupervised model may then be converted into a semi-supervised model upon retraining as feedback data becomes available.

The machine learning model may use univariate or multivariate anomaly detection, or may make any other prediction that provides a confidence or strength or other score of the prediction. In various non-limiting examples, the machine learning model uses an anomaly detection algorithm such as Isolation Forest, Kernel Density Estimation (KDE), or Local Outlier Factor. In other non-limiting examples, the machine learning model makes predictions about categories, workloads, response times, or other data with degrees of confidence, strengths of ratings, or other confidence scores associated with the predictions.

In one example, the machine learning model uses an Isolation Forest algorithm to detect anomalies. The Isolation Forest algorithm is an unsupervised algorithm that uses a decision tree, called an isolation tree, which partitions the data at each node based on common data patterns. The data that requires fewer layers of the tree to isolate down to one data value combination are more likely to be anomalous than the data that is densely grouped with other data and requires more layers to isolate. Isolation trees are used to detect anomalies with short paths from the root node of the tree to the leaf node that represents the one data value combination. Isolation trees work well on large data sets due to the fixed size of the tree and ability of the tree to resolve a data point into anomalous or non-anomalous within constant time. The complexity of the isolation tree as a whole may depend on the density and complexity of the data, but the ability of the isolation tree to detect anomalies may occur within the first N layers of the isolation tree, where N does not scale up linearly with the density and complexity of the dataset and may not scale up at all after the dataset reaches a certain density and complexity. Once an isolation tree has been traversed deep enough to determine that a data point is not anomalous, traversal of the isolation tree to a leaf node is not required.

In another example, the machine learning model uses a KDE algorithm to detect anomalies. The KDE algorithm is a statistics-based algorithm that estimates the shape of a dataset using a kernel density estimator that is determined based on kernels and a smoothing factor. Each kernel sums weights of points nearby. If the kernel density estimator has a low estimated density near a data point or a set of data points, the low estimated density may be an indication that the data point or set of data points is anomalous.

In yet another example, the machine learning model uses a Local Outlier Factor algorithm to detect anomalies. The Local Outlier Factor algorithm determines the density of a point based on the point's distance from k nearest neighbors. Regions of one or more points that have significantly lower density than neighboring regions of one or more points may be detected as outliers or anomalies in a dataset or otherwise serve as an indication that a point may be anomalous.

The machine learning model may also use a neural network that preprocesses the data to create vector embeddings of the data and processes the vector embeddings in layers to determine whether the data is anomalous or not. In the final layer of the neural network, the machine learning model may predict whether or not the point is anomalous with a score or a degree of confidence that is based on information learned from the layers leading up to the final layer.

In a particular example, the machine learning model uses a combination of algorithms to detect anomalies, with outputs of each algorithm serving as a weighted indication of whether or not a given point is anomalous or not in the dataset. The model may learn a relevance of each algorithm to the dataset based on an accuracy of the algorithm at predicting anomalies in training data, and the algorithm may be weighted based on the learned relevance.

### Estimating Accuracy of Machine Learning Models

Whether the model is tuned or not, a remaining set of test data may be used to determine an accuracy of the trained model. The remaining set of test data, which was not used to train or tune the model, may be stored as a “labeled version,” which is a version with known outputs which may be known from being labeled by a human, from being labeled by a machine, or otherwise from being part of or a dimension of the set of known data. The remaining set of test data may be input into the trained model as an “unlabeled version,” which is a version in which the known outputs have been removed for the purpose of testing the model's accuracy. The trained model makes predictions for the unlabeled version that is input into the trained model, and the model outputs predictions as a set of model outputs. The set of model outputs is compared to the labeled version of the set of test data to determine an initial accuracy of the model.

Referring back to FIG. 1, process 100 continues at block 104 to determine an initial accuracy score of the trained model at detecting anomalies in the first set of data items. For example, the accuracy score may reflect a probability that the model correctly identifies an anomaly, or may be weighted based, for example, on elevated risks such as damage to a larger system, due to false positives and/or false negatives. In a particular example, a larger system such as a factory may include a critical process that, if the critical process fails or experiences an unreported anomaly, the critical process may cause significant damage to other machines in the factory. In this particular example, false negatives may be weighted higher than false positives to reward the model for providing slightly more notifications than needed and better protect against false negatives.

Referring back to FIG. 2, system manager 204 includes an accuracy updating service 228 and an accuracy re-evaluation service 230 for determining accuracy scores and evaluating whether or not the accuracy scores satisfied one or more conditions for retraining the model 212. The initial accuracy score determined by service 228 may be evaluated by service 230 to determine if the initial accuracy score meets the one or more conditions before the model is deployed for production for use by anomaly detection service 214 to detect and notify of anomalies via anomaly notification(s) 216 to client(s) 218.

The trained model changes in accuracy over time as the model operates on new data that may vary in unexpected ways from when the model was trained. The accuracy of the model may periodically, continually, or occasionally, synchronously or asynchronously with model predictions, be re-evaluated to improve confidence that the model is making accurate predictions, or to trigger a re-training of the model when such confidence is unsupported by the re-evaluation. The re-evaluation may be performed on unlabeled data for which the model made predictions but for which the accuracy of the predictions was not known at the time the model made the predictions. Re-evaluation may involve determining what the predictions should have been if the model was perfectly accurate in making predictions. Evaluating accuracy of the model consumes resources, though, particularly if the evaluation involves a human review of model outputs. For this reason, re-evaluation is often performed iteratively on small samples depending on the bandwidth and cost of re-evaluation resources. Results of any re-evaluation may be combined with the initial accuracy to determine an aggregate accuracy of the model, which may shift from the initial accuracy determined from the test data.

In one embodiment, a first accuracy score is determined for the trained machine learning model at determining anomalies in a first set of data items, and updated accuracy scores may be determined for supersets of data items including the first set of data items and other data items. The accuracy scores may be determined by providing an unlabeled version of the first set of data items to the trained machine learning model as a set of inputs to generate a set of outputs of the machine learning model. For the test data, the unlabeled version may be stripped of the known labels. For production data, the unlabeled version may exist prior to obtaining feedback on the predictions. The set of outputs from the model may be compared to labeled versions, whether through merging the stripped data back to the original data or by merging the production data with the feedback, to determine a set of incorrectly predicted outputs and a set of correctly predicted outputs. The accuracy score may be based on the incorrectly predicted outputs and correctly predicted outputs, for example, showing a probability of a correctly predicted output.

The accuracy of machine learning models may change over time, for example, due to data drift and/or concept drift, and accuracy should be re-evaluated over time to determine whether retraining is needed. For example, model accuracy may degrade from 90% to 75% over time, or from 99% to 95% over time, and, depending on the configuration, such changes may be considered sufficient for model retraining. Techniques described herein provide an efficient and iterative approach to model re-evaluation and retraining.

Data drift occurs when input data patterns or distributions change over time even though the distribution of output predictions should be similar. Such changes can occur due to changing seasons, changing sensors, normal changes in machine behavior, changes in usage patterns, and for other reasons. For example, the mix of widgets being made by the machines being measured may shift over time as one widget becomes more popular than another widget, but the overall number of errors expected from the machine is expected to stay the same. Although the number of errors or anomalies is expected to stay the same, the model's accuracy in detecting these anomalies may change due to the data drift.

Concept drift occurs when input data patterns and output predictions should change over time based on a change in what is being measured. Such changes can occur due to changes in how the machine is being used (towards safer or less safe modes), changes in safety protocols to catch more errors, changes in the overall safety of the surrounding environment, or changes to using more or less reliable parts. For example, machines may now use a new valve that has a higher (or lower) temperature tolerance than a previously used valve, to decrease the number of safety incidents or to save cost, and the overall number of errors may be expected to change as a result. As the number of errors or anomalies is expected to change, the model's accuracy in detecting these anomalies is likely to change due to concept drift.

### Determining a Region of Prediction Uncertainty

One or a variety of machine learning models may be used on same or different data sets consistent with the techniques described herein. The machine learning model may use univariate or multivariate anomaly detection, or may make any other prediction that provides a confidence or strength or other score of the prediction. In anomaly detection, the confidence of an anomaly may be reflected by the anomaly score, with higher scores more likely anomalous and lower scores less likely anomalous. In another example, if predicting whether a resource workload will go up or down in a window of time, the prediction may reflect a variable analog likelihood that the resource workload will go up or down rather than a binary prediction of whether the resource workload will go up or down. In this example, the likelihood may be used to determine the region of prediction uncertainty as described in more detail herein. In another example, if predicting whether the resource workload will go up or down in a window of time, the prediction may be a binary prediction of whether the resource workload will go up or down along with a confidence score. In this example, the confidence score may be used to determine the region of prediction uncertainty as described in more detail herein. In yet another example, if predicting a category among N candidate categories of a content item, the machine learning model may predict the category with a confidence score. In this example, the confidence score may be used to determine the region of prediction uncertainty as described in more detail herein.

Referring back to FIG. 1, process 100 continues at block 106, where a contiguous anomaly score value region is determined such that the region includes a threshold portion of incorrectly labeled outputs or otherwise has more prediction uncertainty than other regions of anomaly score values. The region of prediction uncertainty may include outputs from the machine learning model labeled as anomalous, and/or outputs of the machine learning model labeled as non-anomalous. In one embodiment, the region includes both. Determining the region allows the system manager to filter, in block 110, and selectively sample, in block 112, data with a focus on predictions that are more likely inaccurate than other predictions.

Referring back to FIG. 2, feedback sampling and collection service 220 determines a contiguous anomaly score value region such that the region has more prediction uncertainty than other regions of anomaly values. Feedback sampling and collection service 220 may then use the region to filter and select items for which feedback is requested from reviewer(s) 224.

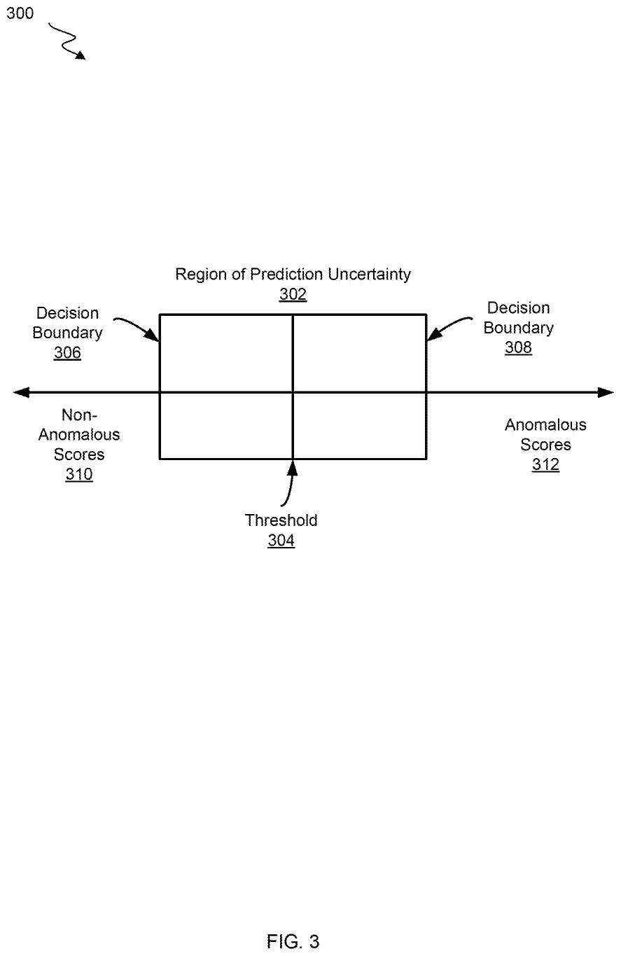

FIG. 3 illustrates a diagram 300 showing a region of prediction uncertainty 302 from which to sample items for feedback collection. As shown, region of prediction uncertainty 302 includes decision boundaries 306 and 308. Decision boundary 306 is an anomaly score below which is no longer considered an uncertain prediction. For example, a density of uncertain predictions may be higher within region 302 than below region 302, which are more consistently correct non-anomalous scores 310. Decision boundary 308 is an anomaly score above which is no longer considered an uncertain prediction. For example, a density of uncertain predictions may be higher within region 302 than above region 302, which are more consistently correct anomalous scores 312.

Threshold 304 may be a point at which predictions are most uncertain, which may or may not be a median or average of region 302. In some embodiments, a density of incorrect predictions is higher on one side of region 302 than on another side of region 302. In this embodiment, threshold 304 may be shifted left or right, towards a side with the higher density of incorrect predictions such that one side of region 302 is larger than another side of region 302.

In one embodiment, the machine learning model assigns an anomaly score to each predicted data point. If the score is higher, the point is classified as anomalous; a lower score indicates a non-anomalous or normal point. In another embodiment, the machine learning model assigns a confidence score to a prediction that was made. If the score is lower, the point is classified as low-confidence and potentially inaccurate; a higher score indicates a higher probability of accuracy. The anomaly scores or confidence scores for a dataset may be used to determine what range or other contiguous region of scores encompasses a portion of the inaccurate predictions. The smallest, simplest, most efficiently defined, or otherwise tailored region of scores that encompasses the portion of the inaccurate predictions may be used to establish the region of prediction uncertainty.

The system manager may determine the region of prediction uncertainty as a range or other contiguous region of values that include a portion (relative or absolute) of inaccurate predictions that have been made. The region is “contiguous” by having value-based boundaries that allow a determination to be efficiently made for whether a data point or prediction is within the boundaries and in the region or not within the boundaries and not in the region. The region may be sized or tailored with boundaries adjusted to include at least a portion of the inaccurate values, for example, 10, 20, 25, 30, 40, or 50% of the inaccurate values, or 10, 20, 30, 40, or 50 individual inaccurate values.

The region of prediction uncertainty may be determined based on the test data for the model, which reveals the inputs for which the model provided inaccurate predictions. In one embodiment, the region of prediction uncertainty is determined before any values are predicted by the model, such that predictions may be classified as either falling within or not within the region of prediction uncertainty. In another embodiment, the region of prediction uncertainty is determined after at least some values have been predicted by the model, and the region of prediction uncertainty may account for the inaccurate predictions from the test data and optionally also the inaccurate predictions in parts of the production data for which feedback has been provided. The feedback may cause the region of prediction uncertainty to shift towards values for which predictions were recently inaccurate, with more recent values optionally getting weighed greater than less recent values, or including only those values within a threshold amount of time into the past, such as the past 3 months.

Even without prioritized weighting, recent values may cause an overall shift in the distribution of inaccurate predictions such that boundaries for a smaller, larger, or different region of prediction uncertainty may be defined to more efficiently cover a threshold portion of the inaccurate predictions. For example, recent data may indicate that machines of a certain type account for 25% of the (total or recent) inaccurate predictions when the temperature on those machines is between a high bound and a low bound, and the region of uncertainty may be bounded by the high bound and low bound for machines matching the certain type.

The region of values may be univariate or multivariate, to encompass values or combinations of values that account for where the model makes the most inaccurate predictions. The region of values may also include accurate predictions that happen to be near the same values as the inaccurate predictions and fall within the boundaries of the contiguous region. Whether their individual predictions were accurate or not in the training data, points within the region of uncertainty are considered to have high uncertainty relative to points that are not within the region of uncertainty.

### Using a Model to Make Predictions

Once a model is deployed to a production environment of a system, the model may be used to make predictions for the system. Data is input into the model, and the model predicts whether the data is anomalous or not, or predicts one or more future values or other characterizations of the data. In one embodiment, data is streamed into the model to make live predictions about whether or not the data is anomalous without any user intervention between automatic data collection and the automatic reporting of the anomalies. In another embodiment, the data is collected, and predictions are requested asynchronously with data collection, for example, by a user using a user interface. The prediction may be requested periodically via a user subscribing to predictions and notifications, and/or the predictions may be made during the user session with the user interface.

Referring back to FIG. 1, process 100 continues at block 108, where the trained model is used to detect anomalies in a second set of data items. The second set of data items may be similar or different than the first set of data items, and the predictions for the second set of data items may be more or less accurate than the predictions for the first set of data items. For this reason, the accuracy of the model, as updated in block 114, may increase or decrease based on the predictions from the second set of data items for which feedback is collected in block 112.

Referring back to FIG. 2, anomaly detection service 214 uses trained model 212 to detect anomalies on new or incoming data, which may be stored in database 206 or database 208, or otherwise streamed into anomaly detection service 214 for processing. Upon detecting an anomaly, anomaly detection service 214 may trigger an anomaly notification 216 to client 218, for example, based on client 218's registration to receive anomalies of certain types, from certain machines, or in certain scenarios.

### Filtering Items in the Region of Prediction Uncertainty

The feedback collection process may be streamlined by reducing predictions for which feedback is requested or otherwise for further analysis. This streamlining is helpful to reduce the resources allocated to providing feedback as well as maximizing the benefit of the resources consumed in providing feedback. Collecting feedback for all predictions may disproportionately allocate feedback resources to reviewing predictions for which there is already high certainty or low entropy. In one embodiment, the system manager identifies and focuses on predictions with high uncertainty or prediction entropy to reduce the resources required for feedback collection. The system manager may determine which predictions have high uncertainty based on which predictions have been determined to be inaccurate and which other predictions have been determined based on similar data values, whether accurate or inaccurate.

Referring back to FIG. 1, process 100 continues at block 110, where the system manager may select a subset of data items within the contiguous anomaly score value region. The selected subset may be used for selective sampling in block 112 and iterative updates to the accuracy score in block 114 based on feedback collected on the selectively sampled data items in block 112.

Referring back to FIG. 2, feedback sampling and collection service 220 filters new items for which predictions were made by anomaly detection service 214. The filtering may be based on the contiguous anomaly score value region, which was determined to include more incorrect predictions than other value regions.

A threshold anomaly score may be an anomaly score with a highest degree of uncertainty, which may be used to determine whether or not a data point is anomalous. Points above the threshold anomaly score may be considered anomalous, and points below the threshold anomaly score may be considered non-anomalous. In one embodiment, the threshold point and boundary values are tuned using Optuna, a hyperparameter tuning framework, using real-world and/or synthetic datasets.

In one embodiment, the Optuna hyperparameter tuning framework identifies a threshold point and boundary for a dataset. The Optuna framework identifies the threshold point based on the minimum and maximum anomaly scores, and an initial boundary sized to cover a third of the maximum anomaly score. The boundary may initially be centered in a location or threshold point where the anomaly score leads to the most incorrect predictions, and stretched in one direction or the other based on how many incorrect predictions are on each side of the threshold point. The threshold point may also be used as a marker for the machine learning model to determine whether the prediction should be marked as anomalous or not, with values falling above the threshold anomaly score point marked as anomalous and values falling below the threshold anomaly score point marked as non-anomalous. In an embodiment where the prediction is accompanied by a confidence score rather than an anomaly score, the boundary may encompass a lower portion of the confidence score until a threshold portion of observed incorrect predictions is encompassed by the boundary.

Using the Optuna framework or otherwise, an initial boundary and/or initial threshold point may be shifted based on how many incorrect predictions occur on each side of the threshold point and/or how many incorrect predictions occur within the boundary. The boundary may be shifted toward the side with more incorrect predictions and stretched or shrunk to fit a threshold portion of the incorrect predictions in the dataset. The threshold point may also be shifted based on the new boundary such that the threshold point is the median incorrect prediction within the new boundary, the median prediction within the new boundary, the median prediction within the dataset as a whole, or the prediction with the lowest level of confidence in the dataset as a whole or within the boundary.

In one example, if the initial boundary does not yet include the threshold portion of incorrect predictions, the initial boundary is stretched to include more incorrect predictions and checked again. This process may be repeated until the initial boundary covers the threshold portion of incorrect predictions. The boundary may also be shifted to the left or right to balance the number of incorrect predictions on each half or section of the boundary. This shifting may cause predictions that were initially on the right side of the boundary to be on the left side of the boundary, or vice versa, such that the boundary covers lower anomaly scores or higher anomaly scores than the overall average or median anomaly score. The process may conclude with the current region of prediction uncertainty when the boundary covers the threshold portion of incorrect predictions and the distribution of incorrect predictions within the boundary satisfies one or more balancing conditions, if any. Alternatively, the process may conclude with the current region of prediction uncertainty when the process has iterated a threshold number of times (e.g., 100, 300, or 500) to attempt to optimize the region, even though further attempts could be made at optimizing the region. In this embodiment, the region may fall short of satisfying one or more conditions, such as covering the threshold number of incorrect predictions and/or having a balance of incorrect predictions on each side of the region.

Predictions may be made for data falling within the region of uncertainty, and this data and the predictions made may be stored as candidate prompts for feedback (also called “candidate samples”). In other words, the points in the region of uncertainty are “filtered in” to the feedback dataset. Points outside the region of uncertainty may be filtered out of the feedback dataset and not included in the candidate prompts for feedback (not included in the candidate samples). For example, out of 1000 predictions made, the system manager may filter out 800 candidate samples as being outside the region of prediction uncertainty and filter in 200 candidate samples as being inside the region of prediction uncertainty. The 200 candidate samples may be further reduced through selective sampling as described in the next section, resulting in a further reduced set of samples for which feedback is requested.

In some scenarios, filtering the data using the region of prediction uncertainty may cause fewer than a desired or pre-specified amount of samples for which feedback can be provided. In one embodiment for this scenario, predictions may be aggregated until the pre-specified amount of samples is available, at which point the pre-specific amount of samples can be provided to the user without selective sampling as the number of samples is already at or below the pre-specified amount of samples that can be reviewed. In another embodiment for this scenario, predictions are held until the number of predictions in the region of prediction uncertainty meets or exceeds a candidate sample limit, and selective sampling according to the techniques described in the next section may be used to reduce the candidate sample limit to the pre-specified amount of samples for which feedback can be provided. In yet another embodiment for this scenario, predictions may be passed along for feedback without selective sampling even though the samples do not meet the pre-specified amount of samples for which feedback can be provided. The feedback may be provided on these samples iteratively, and selective sampling may be needed for a future window of time during which the pre-specified amount of samples is exceeded. If samples have been collected to exceed the pre-specified amount of samples for which feedback can be provided, clustering and selective sampling is used to reduce the samples to the pre-specified amount of samples as described in the next section.

In various embodiments, the accuracy score may be updated iteratively where each updated accuracy score accounts for new data items. In one or more of the iterations, the region of prediction uncertainty may be used to reduce a superset of items for which feedback is requested to a subset of items that match the region of prediction uncertainty.

### Selectively Sampling the Filtered Items

The feedback collection process may be further streamlined by reducing predictions for which feedback is requested or otherwise for further analysis, to further reduce the resources allocated to providing feedback as well as maximizing the benefit of the resources consumed in providing feedback. Even if feedback is limited to those predictions that are in the region of prediction uncertainty, collecting feedback for all points in the region of prediction uncertainty may disproportionately allocate feedback resources to reviewing predictions that are similar to each other. In addition to reducing predictions for analysis by filtering items in the region of prediction uncertainty, the feedback collection process can be further streamlined by selectively sampling the filtered items (also referred to as candidate samples). In one embodiment, the system manager clusters the candidate samples into a plurality of clusters and samples the candidate samples to include a minimum sample from each cluster of the plurality of clusters. The clustering may reduce the number of samples for which feedback is collected in some cases and may not reduce the number of samples for which feedback is collected in other cases. For example, each cluster may include one, two, five, ten, or another number of samples for feedback. By selecting samples across all of the clusters, the system manager gives all data patterns represented by the clusters an equal opportunity or at least a minimum opportunity to update the model.

Referring back to FIG. 1, process 100 continues at block 112, where the subset of data items, filtered based on the contiguous anomaly score value region in block 110, is selectively sampled for feedback, and feedback is collected for the selectively sampled data items. For example, the selective sampling may include clustering the subset of data items and selecting a minimum number of data items from each cluster prior to collecting feedback for the selected items without collecting feedback for the unselected items. In some embodiments, additional feedback is collected for additional items that have been identified for feedback using other processes, other rules or heuristics, or otherwise identified manually or automatically.

Referring back to FIG. 2, feedback sampling and collection service 220 clusters items for which anomaly detection service 214 has made predictions, optionally after filtering out those values that are not in the contiguous anomaly score value region. Feedback sampling and collection service 220 may then selectively sample data items from the clusters such that the selectively sampled items may be used for collecting feedback from reviewer(s) 224.

The number of clusters, number of samples per cluster, and a time period allocated for reviewing samples by a reviewer may be user-configurable in a system management interface provided by the system manager, to fine tune the resources allocated to providing feedback and the samples analyzed as a result of the feedback. For example, the interface may include slider bars representing a number of clusters to be used for selective sampling (e.g., slidable from 1 or 2 to 15 clusters), a number of samples to select per cluster (e.g., slidable from 0 or 1 to 10 or more), and/or a time period allocated for reviewing samples (e.g., slidable from 1 hour or day to 12 hours or days or more).

In one embodiment, the clustering is performed using a density-based clustering algorithm such as density-based spatial clustering of applications with noise (DBScan) on the candidate samples. DBScan considers points to be reachable to each other if they are within a configurable distance from each other. The DBScan algorithm determines a point, which may be a random point or a point in a region that is most dense. If the point has at least N points within the configurable distance, the point is defined as a core point. The cluster including the core point is expanded for each other point that was within the configurable distance of the core point, determining if those other points also have N points within the configurable distance. The cluster is expanded to include the neighboring points until there are no more points to explore that have N points within the configurable distance of a point in the cluster. Then other points are explored outside the cluster in a similar way, to form other clusters. Noise is determined to be a point that is not part of a cluster and also does not have N points within the configurable distance. If there is any remaining noise after clusters have been identified, the DBScan algorithm may cluster remaining noise together in a cluster, or may cluster the noise into separate clusters.

In another embodiment, the clustering is performed using k-means clustering on the candidate samples. K-means determines k centroids for clusters and assigns a point to a cluster based on the point's distance from the centroid. K-means may then re-determine new centroids for each cluster based on the point that is closest to the center of each resulting cluster, resulting in a new set of clusters. The centroids of the new sets of clusters may be re-determined as well, and K-means may conclude with a set of clusters when the cluster memberships and/or centroids stop changing beyond a certain threshold amount of change.

In another embodiment, clustering may be used to otherwise optimize coverage by the clusters of the variance in the dataset, or the portions of the variance that are not already covered by other clusters. Other clustering methods may also be used.

Regardless of the clustering method used, candidate samples may be placed in resulting clusters based on the values of the data points and/or resulting predictions for the data points. The resulting clusters may be used for selectively sampling from among the candidate samples, to ensure that samples are obtained from each cluster of candidate samples. In one embodiment, the system manager attempts to obtain an even number of samples from each cluster until the candidate samples are exhausted for a cluster or until a threshold number of samples is obtained.

In a particular example, recent predictions made by a machine learning model over the past period of, for example, an hour, include a set of 200 candidate samples in the region of uncertainty. The set of 200 candidate samples may be clustered into 5 clusters using the DBScan algorithm, and the system manager may selectively sample 10 samples from each cluster for a total of 50 samples from the 200 candidate samples. The system manager may randomly select samples from the yet-to-be-selected candidate samples unless the candidate sample is in a cluster that is overrepresented or proportionally represented already among the selected samples. If the cluster is already overrepresented or proportionally represented among the selected samples, another sample may be selected at random from the yet-to-be-selected candidate samples until a candidate sample is selected that is not already overrepresented or proportionally represented. Proportional representation in the example would occur if a cluster of the 5 clusters already has 10 selected candidate samples when 50 total candidate samples will be selected, which may be determined by dividing the total candidate samples by the number of clusters. In this scenario, selecting another candidate sample from the cluster would result in underrepresentation of selected candidate samples from another of the 5 clusters due to the cap of 50 total selected candidate samples which equates to 10 candidate samples per cluster of 5 clusters. The system manager may prompt a reviewer for feedback on the 50 samples, and the feedback may be used to update the accuracy score and trigger any further action such as retraining the model if downstream conditions are satisfied to trigger the further action.

The filtered set of data items may be a subset of the total data items for which a machine learning model has provided new predictions, and the clusters may be determined using the filtered set of data items. The selectively sampled data items from the clusters may be a further subset of the filtered set of data items for which clusters were determined. Each time a subset is taken of data items, the number of data items remaining to use for feedback collection may be reduced (strict subset), or be reduced or stay the same (standard subset) where a reduction is not needed if the number of items is already below a threshold.

### Iteratively Collecting Feedback

An iterative process is described for analyzing at least some of the predictions that were made, such as those made during a window of time or since a last iteration of feedback collection, and storing results of the feedback to update an accuracy score for the machine learning model and/or to trigger retraining of the model. One additional potential benefit of an iterative approach is that the feedback collected during prior iterations is available as labeled data during model retraining, increasing accuracy of the model with additional training data that exists in the region of prediction uncertainty for previous model(s).

In one embodiment, feedback is requested only for those items filtered to be within the region of prediction uncertainty and selectively sampled from the filtered items based on cluster membership. Targeting feedback only for these items reduces the burden on the reviewer to review large collections of data and make large volumes of decisions, and may increase in overall accuracy if the reviewer's accuracy decreases when the volume of decisions increases. In other embodiments, feedback is requested for the items filtered to be within the region of prediction uncertainty and selectively sampled from the filtered items based on cluster membership, plus additional or supplemental items for which feedback is requested. Supplemental items may be identified by manual review or based on specific targeting of predictions in certain higher-risk or higher-value scenarios, for which human involvement was higher and a reviewer is already familiar with the scenario, for which anomaly notifications were provided and corrected as non-anomalous, for which anomaly notifications were not provided and corrected as missed anomalies, and/or for any other reason. For example, an option to provide supplemental feedback may be included with each reported or notified anomaly, even if the anomaly is not in the region of prediction uncertainty. As another example, certain activities may be used as evidence of a missed anomaly even if the missed anomaly is not specifically identified, such as the manual stopping of a conveyor belt between machines or the pressing of a kill switch to turn off the machine in an emergency.

The set of items for which feedback is provided may include data value combinations that are not present in the training data or other data seen beforehand, and the model may make correct predictions for some of those unknown combinations and incorrect predictions for others of those unknown combinations, depending on the data patterns detected. Even if the data patterns were previously seen, the model may not make accurate predictions for rare patterns depending on the complexity of the model and whether the model was trained on the previously seen data.

Referring back to FIG. 2, feedback sampling and collection service 220 sends information about selectively sampled item(s) for feedback 222 to reviewer(s) 224. Reviewer(s) 224 may then provide labeled selectively sampled item(s) 226 back to feedback sampling and collection service 220 so that labels predicted by anomaly detection service 214 may be evaluated against labeled selectively sampled item(s) 226 to determine an accuracy score specific to the feedback items.

### Updating the Accuracy Score

In one embodiment, the accuracy score is updated to account for recently collected feedback and initially or otherwise previously collected feedback. The recently collected feedback may be weighted equally with the previously collected feedback, or, in another embodiment, weighted greater than the previously collected feedback to place a greater emphasis on current model relevance and accuracy over historical model relevance and accuracy. Aside from the time-driven weights for feedback, feedback may also be weighted based on how much feedback was collected in different categories. For example, 100,000 items of feedback or labels in the training data may be weighted 1,000 times greater than 100 items of feedback received after model training (because there are 1,000 times more items of feedback), unless the items of feedback received after model training receive a higher weight due to timing or recency.

Referring back to FIG. 1, process 100 continues at block 114, where an updated accuracy score is determined based on the collected feedback for the selectively sampled data items and based on the initial or otherwise previously determined accuracy score. The updated accuracy score may account for the collected feedback and previously determined accuracy score based on a number of data items represented in those sets, and/or with weighting determined based on recency of the feedback, expertise of the reviewer, accuracy measurements for the reviewer, and/or relevance to the current data and process pipeline. For example, a factory may have changed the production pipeline two weeks ago and may discount or disregard feedback scores collected before the change in the production pipeline. Feedback may be discounted in weight or filtered out (disregarded) based on a variety of factors, including time, process changes, reviewer quality, machines involved, etc.

Referring back to FIG. 2, labeled selectively sampled item(s) 226 are provided back to feedback sampling and collection service 220 for use by accuracy updating service 228 to determine an overall accuracy of anomaly detection service 214. The overall accuracy may account for labeled selectively sampled item(s) 226 that were initially correctly or incorrectly labeled by anomaly detection service 214, as well as previous accuracy score(s) that reflect previous items correctly or incorrectly labeled using trained model 212. The scores may be weighted based on volume, recency, or any other factor.

In order to combine the feedback score and the existing accuracy score, a feedback score for the feedback data may be determined based on an accuracy of the predictions indicated by the feedback data. If the predictions indicated anomalies and the feedback indicated anomalies, the predictions were true positives or correct. If the predictions indicated non-anomalies and the feedback indicated non-anomalies, the predictions were true negatives or correct. Otherwise, the predictions were incorrect as false positives (predicted anomaly but feedback indicated not anomaly) or false negatives (predicted non-anomaly but feedback indicated anomaly). The feedback score may be combined with the existing accuracy score based on the weights as indicated above. If a total number of accuracy items is T and a number of feedback items is F, the total accuracy score is equal to (existing_accuracy·(T−F)+feedback_accuracy·F)/T, if the feedback items and existing or training data items are weighted equally. Otherwise, a weight, w, may be included for feedback items that the total accuracy score is equal to (existing_accuracy·(T−w F)+feedback_accuracy·w F)/T, where 0<w<T/F and w>1 weighs feedback items higher than existing items and w<1 weighs feedback items lower than existing items.

In one example, a given set of 50 total selected candidate samples, F, from 5 clusters may include 5 samples that are incorrect spread over two different clusters and 45 samples that are correct spread over the five different clusters, as determined from the feedback. The accuracy of the sample (feedback_accuracy) is then 90%, which may be higher or lower than the accuracy of the training data or test data (existing_accuracy). If the accuracy is higher, the total accuracy of the model may be adjusted up, and if the accuracy is lower, the total accuracy of the model may be adjusted down. The total amount of data accounting for the total accuracy may be adjusted up by the 50 new items in either case, reflecting a larger corpus of data (by 50 items) that has been used to determine the accuracy score. That larger corpus of data and the corresponding total accuracy score for the larger corpus of data may be used as the existing number of accuracy items (T₂-F₂) for a next iteration of updating the accuracy score for a next iteration of feedback items, F₂, that can be incorporated into the larger corpus of data, iteratively increasing the larger corpus of data for which feedback has been received.

### Determining Whether to Trigger an Action

The feedback and updated accuracy score help the system manager maintain an accurate model, learn from past mistakes, adapt to new threat patterns, manage data drift, and/or manage concept drift.

If the accuracy score drops below a level defined by one or more conditions, the system manager may trigger a retraining of the model to better account for a larger corpus of known data since the model was last trained by re-selecting parameters and assigning weights based on the relative importance of each parameter to a prediction, re-tuning hyperparameters, and re-evaluating the model using the larger corpus of known data. Retraining the model may consume a significant amount of resources, and the accuracy score helps the system manager ensure these resources are being used in appropriate circumstances without wasting resources on retraining a model with an accuracy score that would not otherwise satisfy the one or more conditions for retraining. When the model is eventually retrained, the retraining may take advantage of the additional feedback collected iteratively in the region of prediction uncertainty, improving the long-term accuracy of the model.

The one or more conditions for retraining may include just an accuracy score threshold or cutoff, such as 85% or 90% accuracy, or the one or more conditions may include any combination of one or more accuracy score thresholds, one or more time thresholds such as an amount of time that has passed since a last retraining, one or more functions of accuracy score and time, where higher accuracy scores are needed when more time has passed since a last retraining, and/or one or more other thresholds or functions that promote long-term accuracy of the model. The one or more conditions may also include conditions based on data drift or concept drift that are independently derived but included in the retraining determination.

Referring back to FIG. 1, process 100 continues at block 116 to determine whether the updated accuracy score satisfies conditions for retraining. If so, in block 120, the system manager triggers a retraining of the machine learning model in block 102 based on a superset of data items including the selectively sampled data items for which feedback was collected in blocks 112. If not, in block 118, the system manager continues to use the trained model to detect anomalies in block 108, with the last updated accuracy score being used as the new initial accuracy score in block 114. A new last updated accuracy score may be used for each iteration of blocks 108-116, based on the feedback that was seen prior to block 114 in prior iterations.

Referring back to FIG. 2, accuracy re-evaluation service 230 determines whether the updated accuracy score satisfies condition(s) for retraining. The condition(s) may be stored in database 206 based on previously configured model management settings from a client, which may be the same or a different client than client 218. For example, the condition(s) may be based on the accuracy score and/or an amount of time that has passed since the model was last trained. Accuracy re-evaluation service 230 may then determine whether to re-build the model using model builder 210, or to postpone model retraining until condition(s) are satisfied by a future update from accuracy updating service 228.

In various embodiments, according to techniques described herein, the system manager collects iterative feedback in multiple iterations of feedback collection, determines to keep the existing model as accurate enough in multiple iterations, retrains the model as not accurate enough in multiple iterations (many of which may have been determined to be accurate enough in other iterations) using initial labels and additional feedback collected in the multiple iterations of feedback collection, and continues the iterative process of collecting feedback, keeping the model, and retraining the model continuously or periodically to maintain current relevance of the model to current predictions over time.

A decision made to retrain the model may trigger an initiation of model retraining. Once initiated, model retraining may involve a scheduling of eventual model retraining based on workload factors and resource consumption expectations or an immediate retraining of the model. Model retraining may also involve a data preparation step, as data is collected, normalized, and otherwise processed from databases to serve as input into the model builder. While the model is being retrained, the existing model may be taken offline or continued to be used for anomaly detection. The models can exist concurrently, and one model or the other can be marked as the active model. When a new model is generated from retraining, the old model that existed prior to retraining may be taken offline as the new model is made active for production.

In one embodiment, the feedback received for samples from a first model are used to train and validate a second model. The feedback received for samples from the first model may be split into a training subset and a validation subset. The training subset of the feedback set be combined with the original training set or a newly determined training set (e.g., with a different split between training set, validation set, and test set from the original dataset) to create an augmented training set that incorporates the training subset of the feedback set. The validation subset of the feedback set may be used as an independent evaluation to assess the performance of the second model with respect to the data observed after the first model was trained. Scores on the validation set and the validation subset of the feedback set may be combined by taking a weighted average that may account for the recency of the validation subset of the feedback set and/or the amount of data represented by the validation subset of the feedback set compared to the amount of data represented by the validation set from the original dataset used for the first model. Combining scores for the validation set and the validation subset of the feedback set validates that the model accurately identifies both old and new anomalous patterns effectively. Hyperparameters may be tuned using this combined score as the objective of the tuning framework.

### Enhancing Anomaly Detection Systems for the Internet of Things

In various embodiments, anomaly detection systems may be enhanced for the Internet of Things (“IoT”) applications and/or other supply chain analytics embodiments. An IoT platform may receive data from multiple sensors that report a variety of metrics (e.g., temperature, speed, position, pressure, noise, image data, vibration, motion, personnel detection, mode of operation, task being performed, etc.), and the IoT platform may display information about the sensors and the objects they monitor over time, with the ability to configure anomaly reporting preferences and register new devices or sensors with the platform. The registered sensors may report to the platform periodically, sporadically, or otherwise be pushed into the platform or pulled in by the platform. The anomaly reporting preferences may specify whether and who should be notified in the case of detected anomalies for different objects or different sensors, and what levels of confidence may be needed to trigger different types of notification or automated action in the system.

The IoT platform may also have control interfaces registered for different connected devices, where the IoT platform may trigger automated actions on the registered devices consistent with the operations supported by the control interface supported by the registered device and managed by the IoT platform. For example, the IoT platform may use an API exposed on the device to turn on the device, turn off the device, turn on or off a light, adjust the frequency of metric monitoring, cause display of a message (status notification or instructions), image, or icon, cause output of a sound, trigger a notification, speed up or slow down the device, or adjust the power consumption of the device, etc. Any such actions may be triggered automatically in response to an anomaly or other event detected from the sensors, for example, according to a predefined rule configured by one or more users, and/or manually via use of the platform.

IoT sensors embedded in machinery and equipment can continuously collect data on various parameters like temperature, vibration, and noise levels. For example, the sensors may monitor injection molding, thermoforming, and other industrial or manufacturing processes. Anomaly detection techniques can monitor these sensor readings and detect deviations from normal behavior, such as variations from desired temperature range. The trained machine learning model may predict multivariate anomalies in a physical system being monitored by the sensors, which measure physical properties of the physical system. The sensors may be separately identified and tracked in an anomaly detection platform, for example, by a sensor ID that is assigned to a hardware address, network address, and/or sensor type when the sensor is registered with the system. The sensors stream data items into the anomaly detection platform using connections that provide sensor-identifying information so anomalies can be traced back to the individual parts of the physical system where problems are occurring. Deviations from normal temperature conditions can result in uneven cooling or issues with heating elements. Identifying anomalies can help predict and prevent equipment failures, optimize production quality, reduce defects, reduce unplanned downtime and maintenance costs, and otherwise improve overall efficiency.

Management systems may use machine learning models to learn patterns from historical data and apply those models to new data to identify anomalies. IoT and Supply Chain Management (SCM) systems operate in dynamic and evolving environments. As the systems operate and encounter real-world scenarios, they are likely to face new and previously unseen anomalies that the initial models were not trained to detect. These changing circumstances can result in false alarms (false positives) or missed detections (false negatives), which, depending on the use case, could be devastating. By collecting feedback on the model predictions and incorporating the feedback into the retraining process, anomaly detection models can learn from past mistakes and adapt to the changes in data distribution and patterns. Collecting feedback for each prediction is impractical in systems that make hundreds, thousands, or even millions of predictions a week, day, or even hour, as such feedback would involve a large commitment of resources that would erode the benefit and efficiency provided by the machine learning model. Ultimately, the large commitment of resources may still result in false positives or false negatives, as feedback error increases with larger volumes of feedback and more diverse sources of feedback. The system manager uses an adaptive and iterative learning process that makes the system more accurate in distinguishing between normal and anomalous events, reducing false positives and false negatives, by focusing feedback on a reduced set of predictions with high uncertainty. In addition to correcting individual errors, the feedback may also help determine when model retraining is needed.

### Computer System Architecture

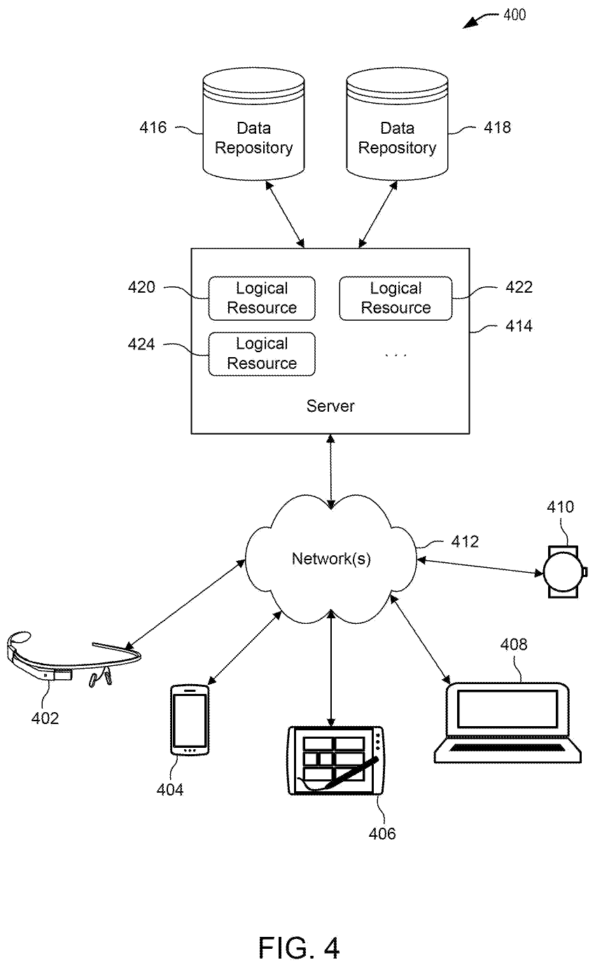

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for detecting anomalies and iteratively and efficiently collecting feedback for model re-evaluation.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for detecting anomalies and iteratively and efficiently collecting feedback for model re-evaluation in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, smart watches, smart glasses, or other wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, Apple Watch®, Meta Quest®, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAPR, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for detecting anomalies and iteratively and efficiently collecting feedback for model re-evaluation. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

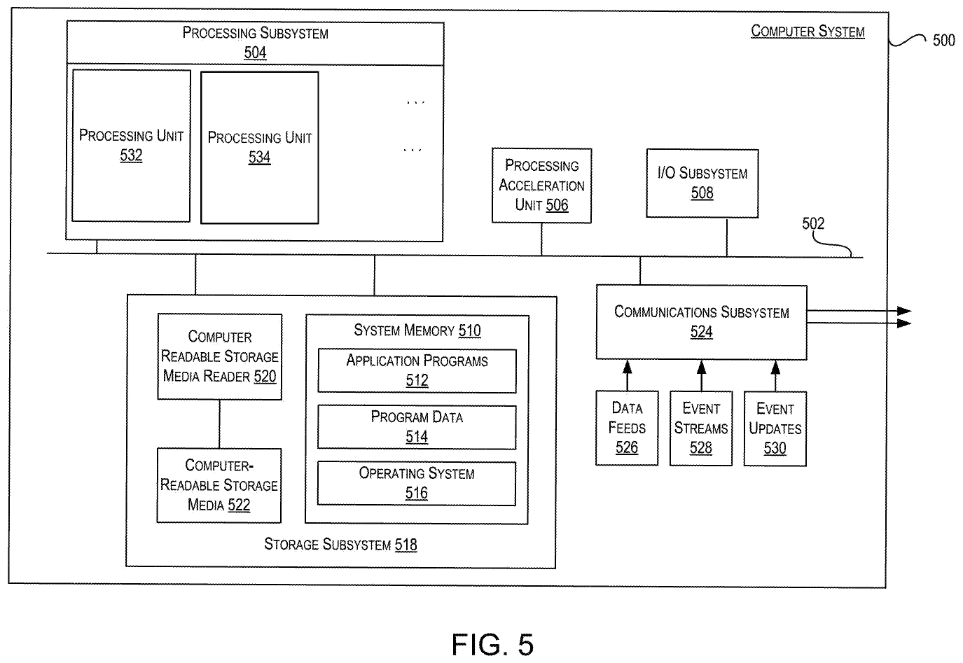

FIG. 5 illustrates an exemplary computer system 500 that may be used to implement certain aspects. As shown in FIG. 5, computer system 500 includes various subsystems including a processing subsystem 504 that communicates with a number of other subsystems via a bus subsystem 502. These other subsystems may include a processing acceleration unit 506, an I/O subsystem 508, a storage subsystem 518, and a communications subsystem 524. Storage subsystem 518 may include non-transitory computer-readable storage media including storage media 522 and a system memory 510.

Bus subsystem 502 provides a mechanism for letting the various components and subsystems of computer system 500 communicate with each other as intended. Although bus subsystem 502 is shown schematically as a single bus, alternative aspects of the bus subsystem may utilize multiple buses. Bus subsystem 502 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 504 controls the operation of computer system 500 and may comprise one or more processors, application specific integrated circuits (ASICs), or field programmable gate arrays (FPGAs). The processors may include be single core or multicore processors. The processing resources of computer system 500 can be organized into one or more processing units 532, 534, etc. A processing unit may include one or more processors, one or more cores from the same or different processors, a combination of cores and processors, or other combinations of cores and processors. In some aspects, processing subsystem 504 can include one or more special purpose co-processors such as graphics processors, digital signal processors (DSPs), or the like. In some aspects, some or all of the processing units of processing subsystem 504 can be implemented using customized circuits, such as application specific integrated circuits (ASICs), or field programmable gate arrays (FPGAs).

In some aspects, the processing units in processing subsystem 504 can execute instructions stored in system memory 510 or on computer readable storage media 522. In various aspects, the processing units can execute a variety of programs or code instructions and can maintain multiple concurrently executing programs or processes. At any given time, some or all of the program code to be executed can be resident in system memory 510 and/or on computer-readable storage media 522 including potentially on one or more storage devices. Through suitable programming, processing subsystem 504 can provide various functionalities described above. In instances where computer system 500 is executing one or more virtual machines, one or more processing units may be allocated to each virtual machine.

In certain aspects, a processing acceleration unit 506 may optionally be provided for performing customized processing or for off-loading some of the processing performed by processing subsystem 504 so as to accelerate the overall processing performed by computer system 500.

I/O subsystem 508 may include devices and mechanisms for inputting information to computer system 500 and/or for outputting information from or via computer system 500. In general, use of the term input device is intended to include all possible types of devices and mechanisms for inputting information to computer system 500. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 500 to a user or other computer. User interface output devices may include a display subsystem, indicator lights, or non-visual displays such as audio output devices, etc. The display subsystem may be a cathode ray tube (CRT), a flat-panel device, such as that using a light emitting diode (LED) display, a liquid crystal display (LCD) or plasma display, a projection device, a touch screen, a computer monitor and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 518 provides a repository or data store for storing information and data that is used by computer system 500. Storage subsystem 518 provides a tangible non-transitory computer-readable storage medium for storing the basic programming and data constructs that provide the functionality of some aspects. Storage subsystem 518 may store software (e.g., programs, code modules, instructions) that when executed by processing subsystem 504 provides the functionality described above. The software may be executed by one or more processing units of processing subsystem 504. Storage subsystem 518 may also provide a repository for storing data used in accordance with the teachings of this disclosure.

Storage subsystem 518 may include one or more non-transitory memory devices, including volatile and non-volatile memory devices. As shown in FIG. 5, storage subsystem 518 includes a system memory 510 and a computer-readable storage media 522. System memory 510 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 500, such as during start-up, may typically be stored in the ROM. The RAM typically contains data and/or program modules that are presently being operated and executed by processing subsystem 504. In some implementations, system memory 510 may include multiple different types of memory, such as static random access memory (SRAM), dynamic random access memory (DRAM), and the like.

By way of example, and not limitation, as depicted in FIG. 5, system memory 510 may load application programs 512 that are being executed, which may include various applications such as Web browsers, mid-tier applications, relational database management systems (RDBMS), etc., program data 514, and an operating system 516. By way of example, operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 522 may store programming and data constructs that provide the functionality of some aspects. Computer-readable media 522 may provide storage of computer-readable instructions, data structures, program modules, and other data for computer system 500. Software (programs, code modules, instructions) that, when executed by processing subsystem 504 provides the functionality described above, may be stored in storage subsystem 518. By way of example, computer-readable storage media 522 may include non-volatile memory such as a hard disk drive, a magnetic disk drive, an optical disk drive such as a CD ROM, digital video disc (DVD), a Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 518 may also include a computer-readable storage media reader 520 that can further be connected to computer-readable storage media 522. Reader 520 may receive and be configured to read data from a memory device such as a disk, a flash drive, etc.

In certain aspects, computer system 500 may support virtualization technologies, including but not limited to virtualization of processing and memory resources. For example, computer system 500 may provide support for executing one or more virtual machines. In certain aspects, computer system 500 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 500. Accordingly, multiple operating systems may potentially be run concurrently by computer system 500.

Communications subsystem 524 provides an interface to other computer systems and networks. Communications subsystem 524 serves as an interface for receiving data from and transmitting data to other systems from computer system 500. For example, communications subsystem 524 may enable computer system 500 to establish a communication channel to one or more client devices via the Internet for receiving and sending information from and to the client devices. For example, the communication subsystem may be used to transmit a response to a user regarding the inquiry for a Chabot.

Communication subsystem 524 may support both wired and/or wireless communication protocols. For example, in certain aspects, communications subsystem 524 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 524 can provide wired network connectivity (e.g., Ethernet) in addition to or instead of a wireless interface.

Communication subsystem 524 can receive and transmit data in various forms. For example, in some aspects, in addition to other forms, communications subsystem 524 may receive input communications in the form of structured and/or unstructured data feeds 526, event streams 528, event updates 530, and the like. For example, communications subsystem 524 may be configured to receive (or send) data feeds 526 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 524 may be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to communicate data from computer system 500 to other computer systems or networks. The data may be communicated in various different forms such as structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 500 depicted in FIG. 5 is intended only as a specific example. Many other configurations having more or fewer components than the system depicted in FIG. 5 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
determining a first accuracy score of a trained machine learning model at determining anomalies in a first set of data items at least in part by:
providing a first unlabeled version of the first set of data items to the trained machine learning model as a first set of inputs to generate a first set of outputs of the trained machine learning model, wherein the first set of outputs is labeled with a first set of anomaly scores; and
comparing the first set of outputs of the trained machine learning model to a first labeled version of the first set of data items to determine a first set of incorrectly labeled outputs;
determining a contiguous anomaly score value region that includes:
a threshold portion of the first set of incorrectly labeled outputs,
one or more outputs of the first set of outputs labeled as anomalous, and
one or more outputs of the first set of outputs labeled as not anomalous;
receiving a second set of data items that have not been labeled;
providing the second set of data items to the trained machine learning model as a second set of inputs to generate a second set of outputs of the trained machine learning model, wherein the second set of outputs is labeled with a second set of anomaly scores;
determining an updated accuracy score of the trained machine learning model at determining anomalies in a superset of data items comprising the first set of data items and the second set of data items at least in part by:
selecting a second subset of data items within the contiguous anomaly score value region, wherein the second subset of data items has fewer items than the second set of data items;
clustering the second subset of data items into a plurality of clusters based at least in part on one or more feature values of the second subset of data items;
selecting a third subset of data items from the second subset of data items such that:
the third subset has fewer items than the second subset, and
the third subset has one or more data items in each cluster of the plurality of clusters;
collecting labeled feedback for the third subset of data items;
determining a second accuracy score at least in part by comparing, from the trained machine learning model, a third subset of labeled outputs of the third subset of data items to the labeled feedback; and
combining the first accuracy score and the second accuracy score;
based at least in part on the updated accuracy score, determining whether the trained machine learning model satisfies one or more conditions for retraining the trained machine learning model;
based at least in part on determining that the trained machine learning model satisfies the one or more conditions, initiating retraining of the trained machine learning model.

2. The computer-implemented method of claim 1, further comprising sending a notification to an administrator of the trained machine learning model, wherein the notification provides a summary comprising the updated accuracy score and a time for the retraining.

3. The computer-implemented method of claim 1, wherein initiating the retraining comprises scheduling the retraining based at least in part on two or more different frequencies by which data items are provided to the trained machine learning model over two or more windows of time, and wherein the retraining is scheduled for a particular window of time of the two or more windows of time.

4. The computer-implemented method of claim 1, wherein the trained machine learning model is trained to predict multivariate anomalies in a physical system, wherein the second subset of data items comprise sensor values from sensors measuring physical properties of the physical system, wherein the sensors are separately identified and tracked in an anomaly detection platform, and wherein the sensors stream the second subset of data items into the anomaly detection platform using connections that provide sensor-identifying information.

5. The computer-implemented method of claim 1, wherein selecting the third subset of data items comprises:
randomly selecting a unique data item from the second subset of data items;
assigning the unique data item to a particular cluster of the plurality of clusters; and
re-performing said randomly selecting if adding the unique data item to the third subset of data items would result in an over-representation of the particular cluster.

6. The computer-implemented method of claim 1, further comprising:
receiving a third set of data items that have not been labeled;
providing the third set of data items to a second trained machine learning model as a third set of inputs to generate a third set of outputs of the second trained machine learning model, wherein the third set of outputs is labeled with a third set of anomaly scores;
determining a second updated accuracy score of the second trained machine learning model at determining anomalies in a second superset of data items comprising the first set of data items and the third set of data items at least in part by:
selecting a fourth subset of data items within a second contiguous anomaly score value region, wherein the fourth subset of data items has fewer items than the third set of data items;
clustering the fourth subset of data items into a second plurality of clusters based at least in part on one or more feature values of the fourth subset of data items;
selecting a fifth subset of data items from the fourth subset of data items such that:
the fifth subset has fewer items than the fourth subset, and
the fifth subset has one or more data items in each cluster of the second plurality of clusters;
collecting second labeled feedback for the fifth subset of data items;
determining a third accuracy score at least in part by comparing, from the second trained machine learning model, a fifth subset of labeled outputs of the fifth subset of data items to the second labeled feedback; and
combining the third accuracy score and a previous accuracy score;
based at least in part on the second updated accuracy score, determining whether the second trained machine learning model satisfies the one or more conditions;
based at least in part on determining that the second trained machine learning model does not satisfy the one or more conditions, adding the second labeled feedback to at least the first set of data items without initiating retraining of the second trained machine learning model.

7. The computer-implemented method of claim 1, wherein retraining the trained machine learning model comprises tuning one or more hyperparameters of the trained machine learning model based at least in part on the third subset of labeled outputs.

8. A computer-program product comprising one or more non-transitory machine-readable storage media, including stored instructions configured to cause a computing system to perform a set of actions including:
determining a first accuracy score of a trained machine learning model at determining anomalies in a first set of data items at least in part by:
providing a first unlabeled version of the first set of data items to the trained machine learning model as a first set of inputs to generate a first set of outputs of the trained machine learning model, wherein the first set of outputs is labeled with a first set of anomaly scores; and
comparing the first set of outputs of the trained machine learning model to a first labeled version of the first set of data items to determine a first set of incorrectly labeled outputs;
determining a contiguous anomaly score value region that includes:
a threshold portion of the first set of incorrectly labeled outputs,
one or more outputs of the first set of outputs labeled as anomalous, and
one or more outputs of the first set of outputs labeled as not anomalous;
receiving a second set of data items that have not been labeled;
providing the second set of data items to the trained machine learning model as a second set of inputs to generate a second set of outputs of the trained machine learning model, wherein the second set of outputs is labeled with a second set of anomaly scores;
determining an updated accuracy score of the trained machine learning model at determining anomalies in a superset of data items comprising the first set of data items and the second set of data items at least in part by:
selecting a second subset of data items within the contiguous anomaly score value region, wherein the second subset of data items has fewer items than the second set of data items;
clustering the second subset of data items into a plurality of clusters based at least in part on one or more feature values of the second subset of data items;
selecting a third subset of data items from the second subset of data items such that:
the third subset has fewer items than the second subset, and
the third subset has one or more data items in each cluster of the plurality of clusters;
collecting labeled feedback for the third subset of data items;
determining a second accuracy score at least in part by comparing, from the trained machine learning model, a third subset of labeled outputs of the third subset of data items to the labeled feedback; and
combining the first accuracy score and the second accuracy score;
based at least in part on the updated accuracy score, determining whether the trained machine learning model satisfies one or more conditions for retraining the trained machine learning model;
based at least in part on determining that the trained machine learning model satisfies the one or more conditions, initiating retraining of the trained machine learning model.

9. The computer-program product of claim 8, wherein the set of actions further includes sending a notification to an administrator of the trained machine learning model, wherein the notification provides a summary comprising the updated accuracy score and a time for the retraining.

10. The computer-program product of claim 8, wherein initiating the retraining comprises scheduling the retraining based at least in part on two or more different frequencies by which data items are provided to the trained machine learning model over two or more windows of time, and wherein the retraining is scheduled for a particular window of time of the two or more windows of time.

11. The computer-program product of claim 8, wherein the trained machine learning model is trained to predict multivariate anomalies in a physical system, wherein the second subset of data items comprise sensor values from sensors measuring physical properties of the physical system, wherein the sensors are separately identified and tracked in an anomaly detection platform, and wherein the sensors stream the second subset of data items into the anomaly detection platform using connections that provide sensor-identifying information.

12. The computer-program product of claim 8, wherein selecting the third subset of data items comprises:
randomly selecting a unique data item from the second subset of data items;
assigning the unique data item to a particular cluster of the plurality of clusters; and
re-performing said randomly selecting if adding the unique data item to the third subset of data items would result in an over-representation of the particular cluster.

13. The computer-program product of claim 8, wherein the set of actions further includes:
receiving a third set of data items that have not been labeled;
providing the third set of data items to a second trained machine learning model as a third set of inputs to generate a third set of outputs of the second trained machine learning model, wherein the third set of outputs is labeled with a third set of anomaly scores;
determining a second updated accuracy score of the second trained machine learning model at determining anomalies in a second superset of data items comprising the first set of data items and the third set of data items at least in part by:
selecting a fourth subset of data items within a second contiguous anomaly score value region, wherein the fourth subset of data items has fewer items than the third set of data items;
clustering the fourth subset of data items into a second plurality of clusters based at least in part on one or more feature values of the fourth subset of data items;
selecting a fifth subset of data items from the fourth subset of data items such that:
the fifth subset has fewer items than the fourth subset, and
the fifth subset has one or more data items in each cluster of the second plurality of clusters;
collecting second labeled feedback for the fifth subset of data items;
determining a third accuracy score at least in part by comparing, from the second trained machine learning model, a fifth subset of labeled outputs of the fifth subset of data items to the second labeled feedback; and
combining the third accuracy score and a previous accuracy score;
based at least in part on the second updated accuracy score, determining whether the second trained machine learning model satisfies the one or more conditions;
based at least in part on determining that the second trained machine learning model does not satisfy the one or more conditions, adding the second labeled feedback to at least the first set of data items without initiating retraining of the second trained machine learning model.

14. The computer-program product of claim 8, wherein retraining the trained machine learning model comprises tuning one or more hyperparameters of the trained machine learning model based at least in part on the third subset of labeled outputs.

15. A system comprising:
one or more processors;
one or more non-transitory computer-readable media storing instructions, which, when executed by the system, cause the system to perform a set of actions including:
determining a first accuracy score of a trained machine learning model at determining anomalies in a first set of data items at least in part by:
providing a first unlabeled version of the first set of data items to the trained machine learning model as a first set of inputs to generate a first set of outputs of the trained machine learning model, wherein the first set of outputs is labeled with a first set of anomaly scores; and
comparing the first set of outputs of the trained machine learning model to a first labeled version of the first set of data items to determine a first set of incorrectly labeled outputs;
determining a contiguous anomaly score value region that includes:
a threshold portion of the first set of incorrectly labeled outputs,
one or more outputs of the first set of outputs labeled as anomalous, and
one or more outputs of the first set of outputs labeled as not anomalous;
receiving a second set of data items that have not been labeled;
providing the second set of data items to the trained machine learning model as a second set of inputs to generate a second set of outputs of the trained machine learning model, wherein the second set of outputs is labeled with a second set of anomaly scores;
determining an updated accuracy score of the trained machine learning model at determining anomalies in a superset of data items comprising the first set of data items and the second set of data items at least in part by:
selecting a second subset of data items within the contiguous anomaly score value region, wherein the second subset of data items has fewer items than the second set of data items;
clustering the second subset of data items into a plurality of clusters based at least in part on one or more feature values of the second subset of data items;
selecting a third subset of data items from the second subset of data items such that:
the third subset has fewer items than the second subset, and
the third subset has one or more data items in each cluster of the plurality of clusters;
collecting labeled feedback for the third subset of data items;
determining a second accuracy score at least in part by comparing, from the trained machine learning model, a third subset of labeled outputs of the third subset of data items to the labeled feedback; and
combining the first accuracy score and the second accuracy score;
based at least in part on the updated accuracy score, determining whether the trained machine learning model satisfies one or more conditions for retraining the trained machine learning model;
based at least in part on determining that the trained machine learning model satisfies the one or more conditions, initiating retraining of the trained machine learning model.

16. The system of claim 15, wherein the set of actions further includes sending a notification to an administrator of the trained machine learning model, wherein the notification provides a summary comprising the updated accuracy score and a time for the retraining.

17. The system of claim 15, wherein initiating the retraining comprises scheduling the retraining based at least in part on two or more different frequencies by which data items are provided to the trained machine learning model over two or more windows of time, and wherein the retraining is scheduled for a particular window of time of the two or more windows of time.

18. The system of claim 15, wherein the trained machine learning model is trained to predict multivariate anomalies in a physical system, wherein the second subset of data items comprise sensor values from sensors measuring physical properties of the physical system, wherein the sensors are separately identified and tracked in an anomaly detection platform, and wherein the sensors stream the second subset of data items into the anomaly detection platform using connections that provide sensor-identifying information.

19. The system of claim 15, wherein selecting the third subset of data items comprises:
randomly selecting a unique data item from the second subset of data items;
assigning the unique data item to a particular cluster of the plurality of clusters; and
re-performing said randomly selecting if adding the unique data item to the third subset of data items would result in an over-representation of the particular cluster.

20. The system of claim 15, wherein the set of actions further includes:
receiving a third set of data items that have not been labeled;
providing the third set of data items to a second trained machine learning model as a third set of inputs to generate a third set of outputs of the second trained machine learning model, wherein the third set of outputs is labeled with a third set of anomaly scores;
determining a second updated accuracy score of the second trained machine learning model at determining anomalies in a second superset of data items comprising the first set of data items and the third set of data items at least in part by:
selecting a fourth subset of data items within a second contiguous anomaly score value region, wherein the fourth subset of data items has fewer items than the third set of data items;
clustering the fourth subset of data items into a second plurality of clusters based at least in part on one or more feature values of the fourth subset of data items;
selecting a fifth subset of data items from the fourth subset of data items such that:
the fifth subset has fewer items than the fourth subset, and
the fifth subset has one or more data items in each cluster of the second plurality of clusters;
collecting second labeled feedback for the fifth subset of data items;
determining a third accuracy score at least in part by comparing, from the second trained machine learning model, a fifth subset of labeled outputs of the fifth subset of data items to the second labeled feedback; and
combining the third accuracy score and a previous accuracy score;
based at least in part on the second updated accuracy score, determining whether the second trained machine learning model satisfies the one or more conditions;
based at least in part on determining that the second trained machine learning model does not satisfy the one or more conditions, adding the second labeled feedback to at least the first set of data items without initiating retraining of the second trained machine learning model.
